(19) United States
(12) Patent Application Publication
(10) Pub. No.: US 2025/0194607 A1
(43) Pub. Date: Jun. 19, 2025

(54) METHOD OF USING/APPLYING A KERATIN HYDROLYSIS PEPTIDE SOLUTION TO PROMOTE THE GROWTH OF SOYBEANS UNDER LOW TEMPERATURE CONDITION

(71) Applicant: CH Biotech R&D Co., Ltd., Nantou City, Nantou County (TW)

(72) Inventors: Jenn Wen HUANG, Taichung (TW); Ching-Chi TSAI, Taichung City (TW); Ming-Ru LIOU, Taichung (TW)

(73) Assignee: CH Biotech R&D Co., Ltd., Nantou City, Nantou County (TW)

(21) Appl. No.: 18/658,834

(22) Filed: May 8, 2024

(30) Foreign Application Priority Data
Dec. 15, 2023 (TW) 112149130

(51) Int. Cl. A01N 63/50; A01N 25/02; A01P 21/00

(52) U.S. Cl. CPC A01N 63/50; A01N 25/02; A01P 21/00

(57) ABSTRACT

Present invention teaches the method of using a keratin hydrolysis peptide (“KHP”) solution to improve the growth of soybean under low temperature conditions. By selectively choosing specific weights of feathers and water, and treating the mixture to a high-temperature high-pressure hydrolysis process, the resulting solution is confirmed to contain at least 253 peptides and then infused to the soil containing the soybean seeds, the solution can also be sprayed to the leaf surface of soybean plants at a specific growth stage. Optionally, the KHP solution can be diluted by water, as disclosed in the specification, for applying to the soil and for spraying to leaf surface of soybean plants.

### PRIORITY CLAIM TO FOREIGN APPLICATION

Applicant hereby makes priority claim to a Taiwan application, number 112149130, having the Taiwan filing date of Dec. 15, 2023.

### BACKGROUND OF THE INVENTION

Present invention disclosed and claimed the method and application of a keratin hydrolysis peptide (“KHP”) solution to promote the growth of soybean under low temperature conditions.

Hydrolyzed keratin has long been used to strengthen hairs, reduce hair splitting and breakage. Other beneficial uses include skin moisturization and wound healing. Keratin hydrolysate has also been known to function as a biofertilizer, boosting plants' growth by enhancing the plants' ability to receive and utilize nutrients, including commonly applied fertilizers.

The KHP solution is made by a hydrolysis process using feathers and water, via a high-temperature and high-pressure process, resulting in a solution that has many beneficial applications in the fields of horticulture, agriculture and potentially other farming businesses.

Among the embodiments disclosed and claimed in this application, one specific embodiment used feathers only, without water, to be treated with the high-temperature and high-pressure process as taught herein to produce a specific version of the KHP solution.

Soybean (scientific name: Glycine max L. Merr.) is an important part of global agricultural businesses; not only is it a staple food, it also is a base for various industrial products. Soybean originated from the Northeastern part of China, with over 5,000 years of cultivation history. The farming and growing of soybeans has spread globally over the past few centuries. In 2020, the global soybean production came out to be 350 million metric tons, at a value of 105.9 billion US dollars. The top five countries of soybean production, based upon 2020 records, are Brazil (34%), U.S.A. (32%), Argentina (13.8%), China (5.5%) and India (3.2%). The top five countries with highest soybean production values are $47 billion USD (U.S.A.), $32.8 billion USD (Brazil), $15.1 billion (China), $3.3 billion USD (Paraguay) and $2.2 billion USD (Canada).

In the U.S.A., mid-Western states are the major soybean farming regions, especially the two states of Illinois and Iowa.

In Taiwan, the soybean farming regions include Changhua, Yunlin, Jiayi, Tainan, Kaohsiung, Pingtung, Hualian and Taitung. Taiwan's soybean production amount ranged from 4,400-4,800 metric tons a year and ranked 73 in the world in 2020.

Soybean contains 20% fat and 40% protein; it is an excellent source of protein and a source material for plant-based cooking oil. Globally, food products made from soybeans and crushed-soybean derivative materials increased more than two-folds in the past 20 years. It is reasonably expected that the demand for more soybean, as well as the quality soybean-based derivative products, will increase substantially.

Soybean is very sensitive to its growth environment, especially related to temperature, with the best temperature range between of 20° C. and 30° C. The best temperature for soybean to germinate is sufficient exposure to lighting is between of 20° C. and 22° C. When temperature is lower than the range of 10° C.-12° C., the germination would be stunted, with lower speed of sprouting. The young seedlings, even when germination happens, are easily subject to various disease and injuries by pests. Overall growth, including subsequent fruition and yield, will have severe negative impact with the adversity of low temperature. Based upon statistical records. Soybean seeds in lower temperature growth environment will have 24% fewer production yield than that of the normal temperature growth.

The present invention's KHP solution and the method of using same is a cost-effective way to improve the growth of soybeans due to the negative impact of low temperature adversity.

During the seeding stage, the KHP solution can be infused into the soil where soybeans are sown. Even in a low light temperature condition, the soybeans treated with the KHP solution shows substantially better growth and development than otherwise, sometimes better than the soybean plant that's grown in normal temperature setting.

The inventors of present application conducted numerous tests and confirmed the effectiveness of applying the KHP solution as disclosed and claimed herein.

### SUMMARY OF THE INVENTION

The keratin solution is primarily based upon feather, which contains 85-91% keratin, 13-15% organic nitrogen, 1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by the mixture of α-amylase and protease to hydrolyze feather waste, resulting in a mixture of amino acids, fatty acids, and sugars. Nurdiawati experimented and adopted certain specific high-temperature and high-pressure setting in the hydrolysis process and discovered that the resulting solution, when mixed with some potassium and other minerals, can boost the growth of Pogostemon cablin and Vigna radiata, as reported in International Journal of Recycling or Organic Waste in Agriculture (8:221-232, 2019).

The inventors of present application, under the aegis of CH Biotech, developed and selected different feather and water compositions to perform the hydrolysis at higher temperature and higher pressure setting, resulting with different keratin hydrolysis peptide (“KHP”) solution that can be used on different crops/plants.

The selected embodiment of present invention uses a mixture of water and feathers, and subject the mixture to a thermal hydrolysis process to create KHP solutions based upon temperature/pressure parameters as noted below.

The inventors used the Dionex UltiMate 3000 UPLC to separate the peptides; an analysis is done via Thermo Orbitrap Fusion Lumos Tribrid Orbitrap mass spectrometry to identify the peptides, which are then subsequently confirmed by looking up the BIOPEP-UWM database.

The solutions are infused to the soil containing the soybean seeds. Alternatively, the solutions can be sprayed to the leaf surface of the soybean seedling at the stage when the first trifoliolate leaf is unrolled.

The solution can be diluted by water, at 50 to 500 ratio by volume, with a prefer dilution ratio of 500 times.

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

Table I (in Sequence Listing XML format) shows the at least 253 peptides and its annotated sequences for the solution generated in accordance with the disclosure of this application. The Sequence Listing XML file complies with the WIPO ST.26 requirements.

Applicant hereby incorporated by reference said Sequence Listing XML file in its entirety as part of the disclosure and specification of the present application.

The Sequence Listing XML file is identified as follows:
File name: Table-I-253_sequence
Created on: Mar. 17, 2024
Size: 216 KB

FIG. 1 shows the comparison of soybean germination rates among the 3 low temperature groups vis-à-vis the normal temperature group.

FIG. 2A show the comparison of soybean above-ground biomass dry weights among the 3 low temperature groups vis-à-vis the normal temperature group.

FIG. 2B shows the comparison of soybean leaf surface areas among the 3 low temperature groups vis-à-vis the normal temperature group.

FIG. 3A shows the location of the hypocotyl and epicotyl where the widths are measured to evaluate the effectiveness of KHP solution application as taught herein.

FIG. 3B shows the comparison of epicotyl widths.

FIG. 3C shows the comparison of hypocotyl widths.

FIG. 4A shows the comparison of underground biomass dry weights among the low temperature groups vis-à-vis the normal temperature group.

FIG. 4B shows the comparison of total root lengths among the low temperature groups vis-à-vis the normal temperature group.

FIG. 4C shows the comparison of root numbers among the low temperature groups vis-à-vis the normal temperature group.

FIG. 5A shows the comparison of above-ground biomass dry weights among the low temperature groups vis-à-vis the normal temperature group when the leaf-spray application is done.

FIG. 5B shows the comparison of leaf surface areas among the low temperature groups vis-à-vis the normal temperature group when the leaf-spray application is done.

FIG. 6A shows the comparison of underground biomass dry weights among the low temperature groups vis-à-vis the normal temperature group when the leaf-spray application is done.

FIG. 6B shows the comparison of total root lengths among the low temperature groups vis-à-vis the normal temperature group when the leaf-spray application is done.

FIG. 6C shows the root numbers among the low temperature groups vis-à-vis the normal temperature group when the leaf-spray application is done.

FIG. 7 shows the comparison of above-ground biomass dry weights, on the 26th day after seeding, among the low temperature groups vis-à-vis the normal temperature group when the leaf-spray application is done.

FIG. 8 shows the comparison of underground biomass dry weights, on the 26th day after seeding, among the low temperature groups vis-à-vis the normal temperature group when the leaf-spray application is done.

### DETAILED DESCRIPTION OF THE INVENTION

The keratin hydrolysis peptide (“KHP”) solution of present invention is made by a high-temperature and high-pressure process to treat a mixture of water and feathers as shown in the parameters herein.

The mixture ratio, temperature, pressure and duration parameters are shown herein:

| | | | Water content | | | | | |
|---|---|---|---|---|---|---|---|---|
| KHP | Feather | Water | in feather | Pressure | Temp. | Time | Mass | Concen. |
| # | (kg) | (kg) | (%) | (kg/cm²) | (° C.) | (min) | (Da) | (ppm) |
| 1 | 50 | 40 | 50% | 12 | 185 | 80 | 593.3~3508.9 | 301500 |
| 2 | 70 | 0 | 46% | 13 | 180 | 40 | 705.9~3194.7 | 381250 |

The hydrolysis process in the first embodiment takes the steps of:
a. Preparing the KHP solution by mixing 50 kg of feathers whose content is 50% water with 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm.

The keratin hydrolysis peptide (KHP) solution of the first embodiment is further filtered and concentrated to 301,500 ppm concentration.

A second embodiment of keratin hydrolysis peptide (KHP) solution, without water, can be made by 70 kg of feathers, with the feathers' water content being 46%, and then treated by the steps of:
a. stirring the feathers in a sealed container;
b. hydrolyzing the feathers in the container with a temperature and pressure setting of 180° C. and 13 kg/cm² for a duration of 40 minutes;
c. using a mass spectrometer to confirm the combination of peptides in the solution to contain at least 253 peptides as listed in the specification whereby their molecular masses are between 705.9 and 3,194.7 Dalton, and the concentration is in the range of 2.0×10⁵˜4.5×10⁵ ppm.

The keratin hydrolysis peptide (KHP) solution of the second embodiment is further filtered and concentrated to 381,250 ppm concentration.

The confirmation of some of the 253 peptides is further done by referencing the BIOPEP-UWM database.

To test the effectiveness of the method disclosed herein to combat the adversity of low temperature, the inventors selected the soybean species of Glycine max, Kaohsiung No. 10, and planted the seeds in starter pots. The pots are placed in controlled rooms, with 16 hours of light during the day, at illumination of 600 mmole/m²·s, and 8 hours night time.

At seeding time, under the set low temperature condition, the solid of each of the selected pots of soybean is infused with 50 ml of KHP solution.

The KHP solutions can be diluted with water, by volume ratio of 1:50-500. In the present application, the inventors preferred the ratio of 1:500 in several of the tests conducted.

The growth conditions are noted in the table below:

| | | | | Application | |
|---|---|---|---|---|---|
| | Temperature (° C.) | | Low Temp | of solution | |
| | Day | Night | duration | at seeding | dilution |
| Normal | 23 | 21 | — | Water | — |
| Group 1 | | | | | |
| Low Temp | 18 | 18 | From 0-6 | Water | — |
| Check 1 | | | days after | | |
| Low Temp | | | seeding | KHP-1 | 100 |
| Exp. 1A | | | | | |
| Low Temp | | | | KHP-1 | 50 |
| Exp. 1B | | | | | |

The soybeans in Normal Group 1 are grown in normal temperature. Water is infused to the roots in the soil starting at seeding time.

Three groups are given low temperature conditions: Low Temp Check 1, Low Temp Exp. 1A and Low Temp Exp. 1B.

For Low Temp Group 1, the day time and night time temperatures are set at 18° C., during seeding time, only water is infused into the roots in the soil.

Low Temp Exp. 1A and Low Temp Exp. 1B are given KHP-1 solutions, diluted at 100 times (noted as 100×) and 50 times (noted as 50×) of water by volume at seeding time.

After six (6) days of low temperature condition, the inventors then take measurement of the germination rates, above-ground bio mass weights and leaf surface areas among the four groups.

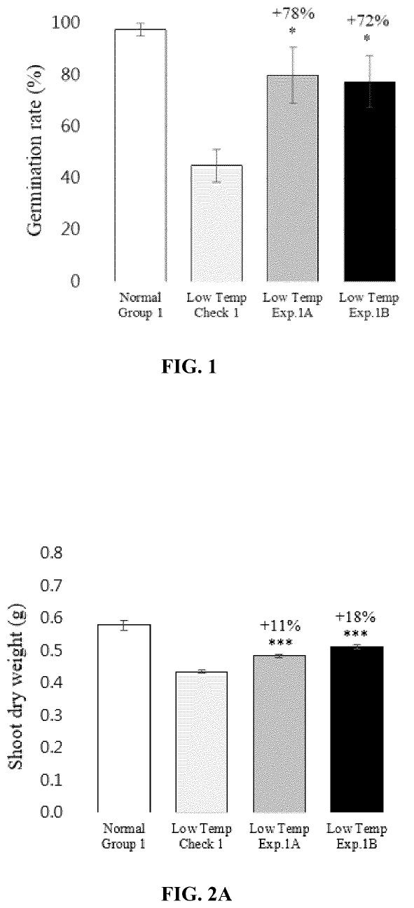

As shown in FIG. 1, the Low Temp Check 1's germination rate is less than half of the normal group, whereas the two low temperature groups (1A and 1B), the soil infused with KHP solutions, show 72%-78% improvement of germination rate than that of the Low Temp Check 1.

The inventors use digital scale (AP224X, Shimadazu) to measure the above-ground bio mass weight; the inventors took photos of the leaves and used WinFOLIA software (WinFOLIA Pro 2014a, Regent Instruments, Inc.) to compute and analyze the leaf areas.

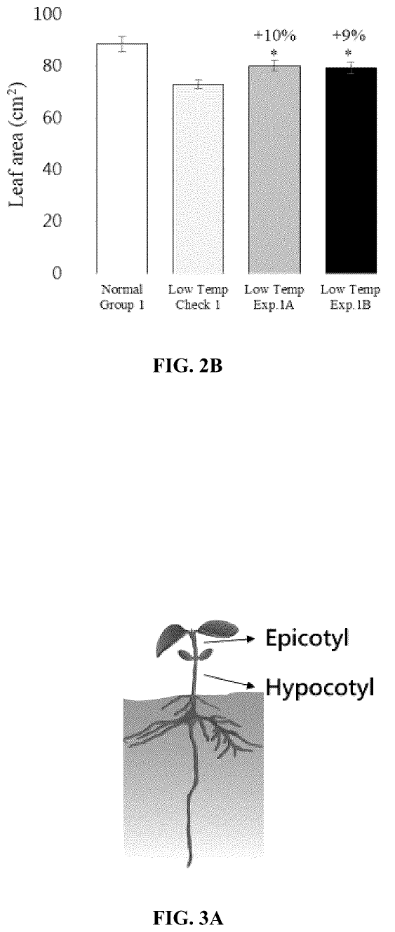

As shown in FIG. 2A, the above-ground biomass dry weight is worse than that of the normal group. The two experiment groups, 1A and 1B, the soil was infused with the KHP solution at seeding time, show 11%-18% increase over that of the Low Temp Check 1 group.

As shown in FIG. 2B, the low temperature condition caused the soybean's leaves to experience slower development. However, the two low temperature experiment groups, 1A and 1B, help with the increase of leaf surface area by 9%-10%, reflecting the effectiveness of soil infusion of the KHP solution at seeding time.

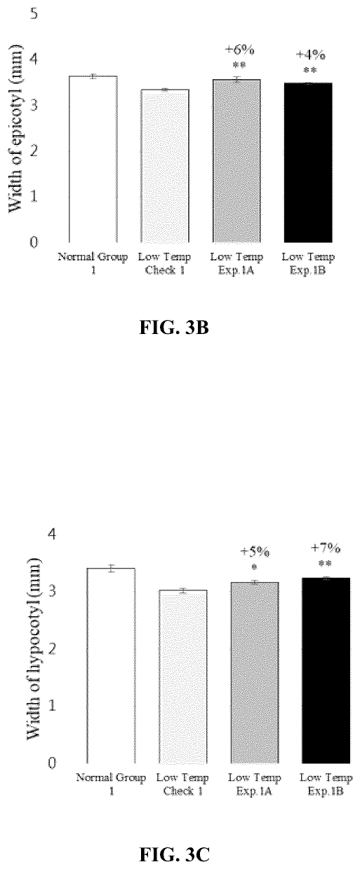

The inventors also compared the dimension of hypocotyl and epicotyl to find out the remedial effectiveness of the KHP application as taught herein. The measured hypocotyl and epicotyl widths are shown in FIG. 3A.

FIG. 3B shows the tabulated result of the epicotyl widths among the 4 groups; FIG. 3C shows the tabulated result of the epicotyl widths among the 4 groups. As can be seen, the two low temperature experiment groups, infused with KHP solution at seeding time, effectively reduced the adversity caused by low temperature conditions.

In addition to measuring the under-ground biomass (root) weight, the inventors also took photos of the root system, using EPSON Expression 11000XL scanner to scan the roots, and ran WinRHIZO software to compute the root numbers and total length.

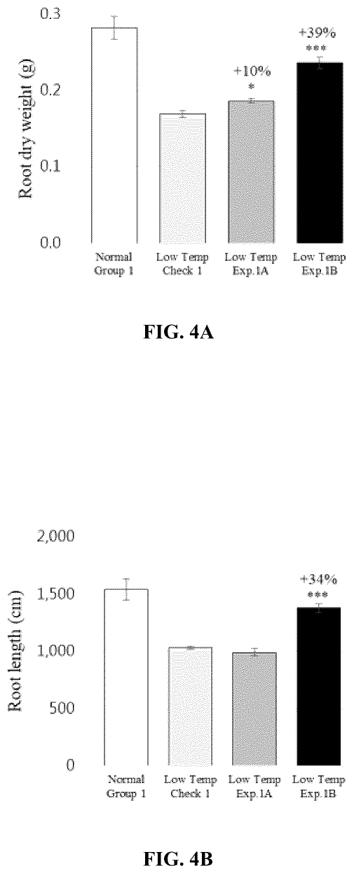

The under-ground dry weight comparison is shown in FIG. 4A. The two low temperature experiment groups, 1A and 1B, show 10%-39% increase over that the low temperature check group1.

The comparisons of total root length and the root numbers are noted in FIGS. 4B and 4C. As can be seen, infusing the KHP solutions into the soil at seeding time greatly help with the root development despite the adversity of low temperature, The Low Temp Exp. 1B group, applied with solution with 50× dilution, increased the root length by 34% and root numbers by 51%, over that of the low temperature check group.

The inventors also used a different method of application based upon the growth stages of soybeans. Specifically, the method of application is by leaf-spraying done at the stage when the seedling's first trifoliolate leaf is unrolled, mostly falling on the 12th day after seeding.

The inventors did the leaf-spray on the 12th day after seeding with 1 mL of KHP solutions, while the soybeans have been given normal temperature setting (day time 25° C.; night time 23° C.) since seeding.

The soybean plants are then placed into an artificial climate room for 7 days (the 13th-19th days after seeding), in a low temperature setting. After this 7-day period, the soybean plants are returned to the normal temperature setting. The inventors, on either the 19th day or the 26th day, take various measurements to assess the effectiveness of KHP solution's application to promote the growth of soybeans.

The table below summarize the parameters of the groupings and conditions.

| | | | | Treatment 12 | |
|---|---|---|---|---|---|
| | Temperature (° C.) | | Low temp | days after | |
| | Day | Night | period | seeding | Dilution |
| Normal | 25 | 23 | — | water | — |
| Group 2 | | | | | |
| Low Temp | 20 | 18 | 13^{th}-19^{th} | water | — |
| Check 2 | | | day after | | |
| Low Temp | | | seeding | KHP -1 | 500 |
| Exp. 2A | | | | | |
| Low Temp | | | | KHP-2 | 500 |
| Exp. 2B | | | | | |
| Low Temp | 15 | 15 | | water | — |
| Check 3 | | | | | |
| Low Temp | | | | KHP-1 | 500 |
| Exp. 3A | | | | | |
| Low Temp | | | | KHP-2 | 500 |
| Exp. 3B | | | | | |

The soybean plants in Normal Group 2 are given normal temperature setting; at the time of the first trifoliolate leaf unrolling, water was sprayed on the surface of the leaves.

Low Temp Check 2 group is given day time 20° C., night time 18° C. low temperature setting. At the time of the first trifoliolate leaf unrolling, water was sprayed on the surface of the leaves.

The Low Temp Exp. 2A and Low Temp Exp. 2B groups are given the same growth conditions as the Low Temp Check group 2, except the leaves are sprayed with KHP-1 and KHP-2 solutions, diluted with 500 times of water by volume (noted as 500×), at the time of the first trifoliolate leaf unrolling.

Low Temp Check 3 group is given day time 15° C., night time 15° C. low temperature setting. At the time of the first trifoliolate leaf unrolling, water was sprayed on the surface of the leaves.

The Low Temp Exp. 3A and Low Temp Exp. 3B groups are given the same growth conditions as the Low Temp Check group 3, except the leaves are sprayed with KHP-1 and KHP-2 solutions, diluted with 500 times of water by volume (noted as 500×), at the time of the first trifoliolate leaf unrolling.

On the 19th day after seeding, measurements are taken to compare the biomass weights (above-ground and underground), leaf surface area, total root length and root numbers. The instruments and software used are the same as depicted previously and need no repetition herein.

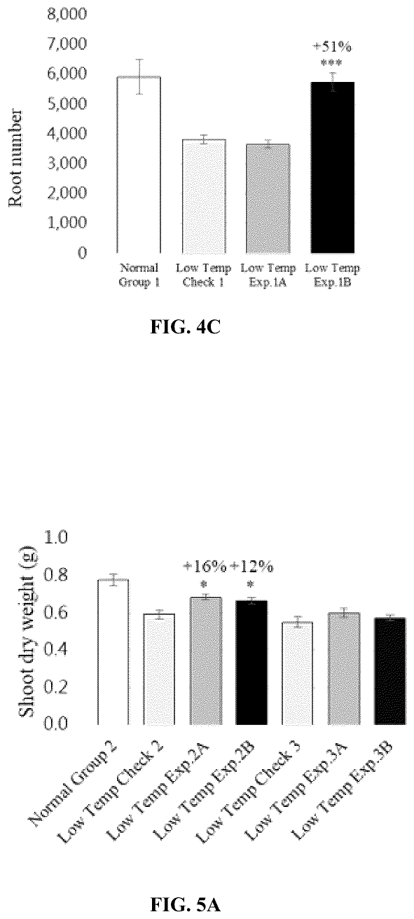

FIG. 5A tabulated the above-ground biomass dry weights from the various groups under the application method of leaf spraying. As can be seen, the two Low Temp Check groups show stunted growth of the soybean plants.

The Low Temp Experiment groups, especially the Exp. 2A and Exp. 2B group, show substantial improvement of above-ground dry weights over that of the Low Temp Check 2 group.

FIG. 5B shows the leaf surface comparisons. The stunted growth of soybeans due to the adversity of low temperature setting is easily seen from Low Temp Check 2 and Low Temp Check 3 groups. The leaf spray application of KHP solutions in the Low Temp Exp. 2A and 2B group effectively boosted the growth of the soybean plants, at 10% over that of the Low Temp Check 2 group.

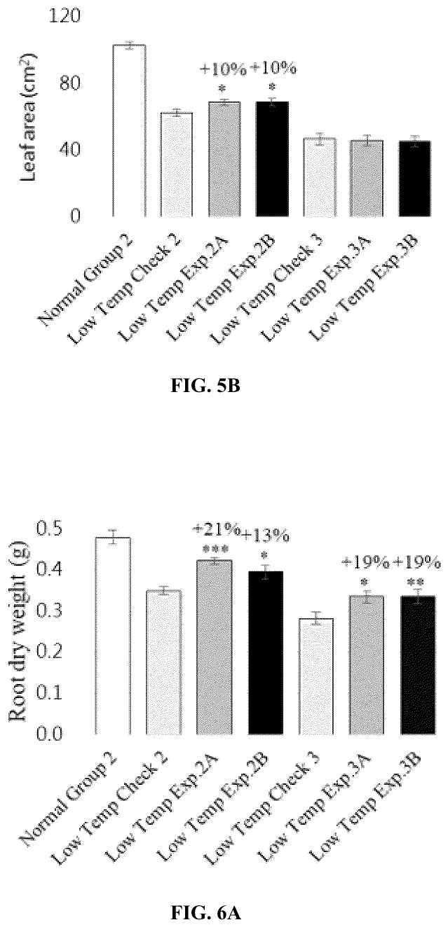

FIG. 6A shows the comparison of underground dry weights. As can be seen, the leaf-spray of KHP solutions as taught herein substantially increased the underground biomass dry weights by 21% and 13% respectively for Low Temp Exp. 2A and 2B groups over that of the Low Temp Check 2 group. The underground biomass dry weight increased 19%, both the Low Temp Exp. 3A and 3B groups, over that of the Low Temp Check 3 group.

FIG. 6B compared the total root length. As can be seen, the Low Temp Exp. 2A and 2B groups show increased total root length by 25% and 18% respectively, over that of the Low Temp Check 2 group. The Low Temp Exp. 3A and 3B groups show increased total root length by 29% and 43% respectively, over that of the Low Temp Check 3 group.

FIG. 6C compared the root numbers. The two Low Temp Check groups show the root number is adversely affected when the soybean plants are exposed to low temperature setting. When sprayed with the KHP solutions as taught in the present application, the 2A, 2B, 3A and 3B experiment groups all show substantially better root numbers.

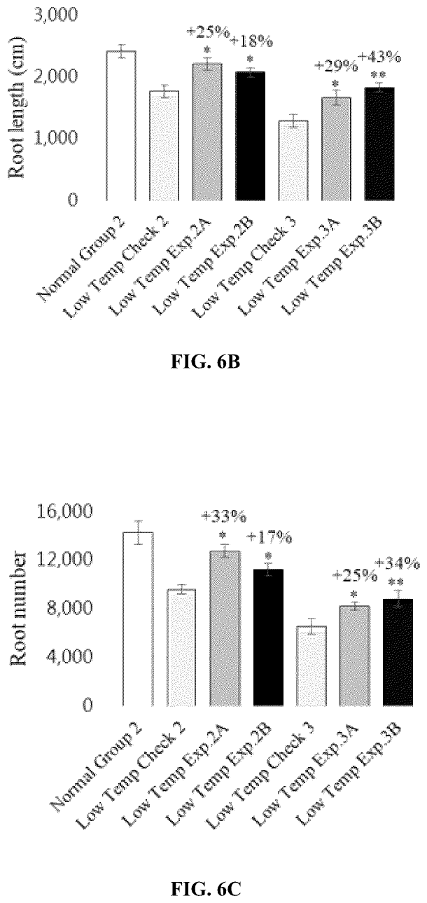

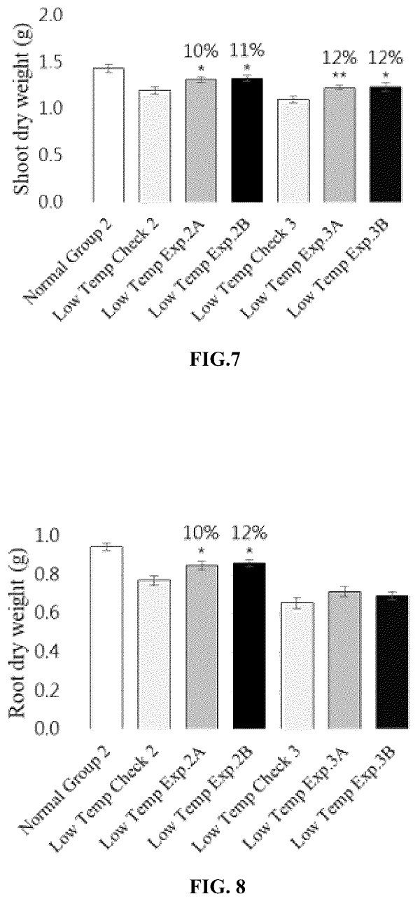

On the 26^{th} day after seeding, the inventors took measurements of above-ground and underground biomass dry weights and tabulated the results in FIGS. 7 and 8.

FIG. 7 shows the improvement of above-ground biomass dry weights in the experiment groups where the soybean plants' leaf surface was sprayed with the KHP solution. The Low Temp Exp. groups 2A, 2B, 3A and 3B show increase of 10%, 11%, 12% and 12% respectively.

FIG. 8 shows the improvement of underground biomass dry weights. The KHP solution leaf spray application as taught in present application substantially promoted the underground biomass dry weights, in the Low Temp Exp. 2A and 2B groups, by 10% and 12% respectively, over that of the Low Temp Check 2 group.

As has been proven by the tests conducted and verified via the scientific analysis/measurement done by the inventors, the method of creating the KHP solution and the method of application will help with the growth and root development of soybean even in low temperature conditions, and will reach the health conditions comparable to soybean plants growing in normal temperature settings.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

1. A method of using a keratin hydrolysis peptide (KHP) solution to promote the growth of soybean under low temperature conditions, comprising the steps of:
a. Preparing the KHP solution by mixing 50 kg of feathers whose content is 50% water and 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜ 4.5×10⁵ ppm; and
d. infusing the KHP solution to the soil containing the soybean seeds or leaf-spraying to the young soybean seedlings.

2. The method of using a keratin hydrolysis peptide solution of claim 1 wherein the solution is diluted with water by volume at the ratio of 1:50-500.

3. The method of using a keratin hydrolysis peptide solution of claim 2 wherein the leaf-spraying is done at the stage when the first trifoliolate leaf is unrolled.

4. The method of using a keratin hydrolysis peptide solution of claim 3 wherein the solution is diluted with water by volume at the ratio of 1:500.

5. A method of using a keratin hydrolysis peptide (KHP) solution to promote the growth of soybean under low temperature condition, comprising the steps of:
a. Preparing the KHP solution by putting 70 kg of feathers whose water content is 46, without mixing any water, in a sealed container;
b. hydrolyzing the mixture in the container with a temperature and pressure setting of 180° C. and 13 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜ 4.5×10⁵ ppm; and
d. infusing the KHP solution to the soil containing the soybean seeds or leaf-spraying to the young soybean seedlings.

6. The method of using a keratin hydrolysis peptide solution of claim 5 wherein the solution is diluted with water by volume at the ratio of 1:50-500.

7. The method of using a keratin hydrolysis peptide solution of claim 6 wherein the leaf-spraying is done at the stage when the first trifoliolate leaf is unrolled.

8. The method of using a keratin hydrolysis peptide solution of claim 7 wherein the solution is diluted with water by volume at the ratio of 1:500.


SEQUENCE LISTING (253 sequences)

SEQ ID NO: 1 - protein, 6 aa, Gallus gallus
FGLSGL

SEQ ID NO: 2 - protein, 7 aa, Gallus gallus
AAVGSSL

SEQ ID NO: 3 - protein, 7 aa, Gallus gallus
TAVGSST

SEQ ID NO: 4 - protein, 6 aa, Gallus gallus
LSLSSQ

SEQ ID NO: 5 - protein, 7 aa, Gallus gallus
FGISGLG

SEQ ID NO: 6 - protein, 6 aa, Gallus gallus
PILSSF

SEQ ID NO: 7 - protein, 7 aa, Gallus gallus
SLLSQGA

SEQ ID NO: 8 - protein, 6 aa, Gallus gallus
FNLRGA

SEQ ID NO: 9 - protein, 8 aa, Gallus gallus
SAAVGSSL

SEQ ID NO: 10 - protein, 6 aa, Gallus gallus
SRVVIQ

SEQ ID NO: 11 - protein, 6 aa, Gallus gallus
SRVVLE

SEQ ID NO: 12 - protein, 8 aa, Gallus gallus
GFGISGLG

SEQ ID NO: 13 - protein, 6 aa, Gallus gallus
SRFSGR

SEQ ID NO: 14 - protein, 6 aa, Gallus gallus
RVVIQP

SEQ ID NO: 15 - protein, 8 aa, Gallus gallus
SAAVGSIL

SEQ ID NO: 16 - protein, 7 aa, Gallus gallus
IVVIGHV

SEQ ID NO: 17 - protein, 9 aa, Gallus gallus
TAVGSSTSA

SEQ ID NO: 18 - protein, 7 aa, Gallus gallus
RVVIQPS

SEQ ID NO: 19 - protein, 7 aa, Gallus gallus
SRVVIQP

SEQ ID NO: 20 - protein, 7 aa, Gallus gallus
PQGEQLQ

SEQ ID NO: 21 - protein, 9 aa, Gallus gallus
RAGAGPPSP

SEQ ID NO: 22 - protein, 7 aa, Gallus gallus
DSRVVIQ

SEQ ID NO: 23 - protein, 8 aa, Gallus gallus
PGPILSSF

SEQ ID NO: 24 - protein, 9 aa, Gallus gallus
PISSGGFGI

SEQ ID NO: 25 - protein, 8 aa, Gallus gallus
ISGLGSRF

SEQ ID NO: 26 - protein, 10 aa, Gallus gallus
SGGFGISGLG

SEQ ID NO: 27 - protein, 7 aa, Gallus gallus
SRFSGRR

SEQ ID NO: 28 - protein, 9 aa, Gallus gallus
PGLALPVLP

SEQ ID NO: 29 - protein, 8 aa, Gallus gallus
SRVVIQPS

SEQ ID NO: 30 - protein, 8 aa, Gallus gallus
PILSSFPQ

SEQ ID NO: 31 - protein, 8 aa, Gallus gallus
LGSGIFWI

SEQ ID NO: 32 - protein, 9 aa, Gallus gallus
GISGLGSRF

SEQ ID NO: 33 - protein, 9 aa, Gallus gallus
VVVTLPGPI

SEQ ID NO: 34 - protein, 8 aa, Gallus gallus
CRLSLSQP

SEQ ID NO: 35 - protein, 11 aa, Gallus gallus
SAAVGSSLSAG

SEQ ID NO: 36 - protein, 11 aa, Gallus gallus
AVGSSTSAAVG

SEQ ID NO: 37 - protein, 9 aa, Gallus gallus
VVTLPGPIL

SEQ ID NO: 38 - protein, 9 aa, Gallus gallus
PGPILSSFP

SEQ ID NO: 39 - protein, 10 aa, Gallus gallus
SAAVGSILSE

SEQ ID NO: 40 - protein, 10 aa, Gallus gallus
VPISSGGFGI

SEQ ID NO: 41 - protein, 8 aa, Gallus gallus
QLAQRNTI

SEQ ID NO: 42 - protein, 9 aa, Gallus gallus
LSGLRSNLS

SEQ ID NO: 43 - protein, 10 aa, Gallus gallus
PSPVVVTLPG

SEQ ID NO: 44 - protein, 10 aa, Gallus gallus
PPPVVVTLPG

SEQ ID NO: 45 - protein, 10 aa, Gallus gallus
ISGLGSRFSG

SEQ ID NO: 46 - protein, 9 aa, Gallus gallus
LALRQSVEA

SEQ ID NO: 47 - protein, 10 aa, Gallus gallus
PLLGPPLLGI

SEQ ID NO: 48 - protein, 10 aa, Gallus gallus
VVTLPGPILS

SEQ ID NO: 49 - protein, 8 aa, Gallus gallus
VTLEDLRR

SEQ ID NO: 50 - protein, 9 aa, Gallus gallus
PILSSFPQN

SEQ ID NO: 51 - protein, 9 aa, Gallus gallus
PILSSFPQD

SEQ ID NO: 52 - protein, 11 aa, Gallus gallus
GTVGVSAGVTR

SEQ ID NO: 53 - protein, 9 aa, Gallus gallus
FGLSRVTLN

SEQ ID NO: 54 - protein, 12 aa, Gallus gallus
TAVGSSTSAAVG

SEQ ID NO: 55 - protein, 10 aa, Gallus gallus
VVVTLPGPIL

SEQ ID NO: 56 - protein, 10 aa, Gallus gallus
PPVVVTFPGP

SEQ ID NO: 57 - protein, 10 aa, Gallus gallus
PPPVVVTFPG

SEQ ID NO: 58 - protein, 10 aa, Gallus gallus
VVIQPSPVVV

SEQ ID NO: 59 - protein, 10 aa, Gallus gallus
FGISGLGSRF

SEQ ID NO: 60 - protein, 10 aa, Gallus gallus
PGPILSSFPQ

SEQ ID NO: 61 - protein, 10 aa, Gallus gallus
FGWSGLGRGL

SEQ ID NO: 62 - protein, 9 aa, Gallus gallus
LEAQLSELR

SEQ ID NO: 63 - protein, 9 aa, Gallus gallus
IVGAWYTVR

SEQ ID NO: 64 - protein, 11 aa, Gallus gallus
LLSPPGLPGLL

SEQ ID NO: 65 - protein, 11 aa, Gallus gallus
VVVTLPGPILS

SEQ ID NO: 66 - protein, 11 aa, Gallus gallus
GFGISGLGSRF

SEQ ID NO: 67 - protein, 11 aa, Gallus gallus
PVVVTLPGPIL

SEQ ID NO: 68 - protein, 11 aa, Gallus gallus
VSQGEITVPSI

SEQ ID NO: 69 - protein, 11 aa, Gallus gallus
SILSEEGVPIS

SEQ ID NO: 70 - protein, 11 aa, Gallus gallus
PVVVTFPGPIL

SEQ ID NO: 71 - protein, 13 aa, Gallus gallus
PISSGGFGISGLG

SEQ ID NO: 72 - protein, 13 aa, Gallus gallus
VGSSTSAAVGSIL

SEQ ID NO: 73 - protein, 11 aa, Gallus gallus
GFLSSAVSLNR

SEQ ID NO: 74 - protein, 12 aa, Gallus gallus
GGFGISGLGSRF

SEQ ID NO: 75 - protein, 11 aa, Gallus gallus
PGPILSSFPQN

SEQ ID NO: 76 - protein, 11 aa, Gallus gallus
PGPILSSFPQD

SEQ ID NO: 77 - protein, 12 aa, Gallus gallus
GGFGWSGLGRGL

SEQ ID NO: 78 - protein, 12 aa, Gallus gallus
PSPVVVTLPGPI

SEQ ID NO: 79 - protein, 12 aa, Gallus gallus
VVVTLPGPILSS

SEQ ID NO: 80 - protein, 12 aa, Gallus gallus
PVVVTLPGPILS

SEQ ID NO: 81 - protein, 12 aa, Gallus gallus
SPVVVTLPGPIL

SEQ ID NO: 82 - protein, 11 aa, Gallus gallus
RVVIQPSPVVV

SEQ ID NO: 83 - protein, 11 aa, Gallus gallus
QALTEVYAKAN

SEQ ID NO: 84 - protein, 10 aa, Gallus gallus
IETLTQFLGW

SEQ ID NO: 85 - protein, 13 aa, Gallus gallus
GFGSRSLVGLGGT

SEQ ID NO: 86 - protein, 14 aa, Gallus gallus
AVGSSTSAAVGSIL

SEQ ID NO: 87 - protein, 12 aa, Gallus gallus
PVVVTFPGPILS

SEQ ID NO: 88 - protein, 14 aa, Gallus gallus
VGSSTSAAVGSILS

SEQ ID NO: 89 - protein, 13 aa, Gallus gallus
GFGISGLGSRFSG

SEQ ID NO: 90 - protein, 13 aa, Gallus gallus
SGGFGISGLGSRF

SEQ ID NO: 91 - protein, 14 aa, Gallus gallus
VPISSGGFGISGLG

SEQ ID NO: 92 - protein, 12 aa, Gallus gallus
VVIQPSPVVVTL

SEQ ID NO: 93 - protein, 13 aa, Gallus gallus
SILSEEGVPISSG

SEQ ID NO: 94 - protein, 13 aa, Gallus gallus
VMGCKAAGASRII

SEQ ID NO: 95 - protein, 13 aa, Gallus gallus
SPVVVTLPGPILS

SEQ ID NO: 96 - protein, 12 aa, Gallus gallus
SRVVIQPSPVVV

SEQ ID NO: 97 - protein, 13 aa, Gallus gallus
PSPVVVTLPGPIL

SEQ ID NO: 98 - protein, 12 aa, Gallus gallus
RVVIQPSPVVVT

SEQ ID NO: 99 - protein, 13 aa, Gallus gallus
PPPVVVTLPGPIL

SEQ ID NO: 100 - protein, 15 aa, Gallus gallus
GVPISSGGFGISGLG

SEQ ID NO: 101 - protein, 13 aa, Gallus gallus
VIQPSPVVVTLPG

SEQ ID NO: 102 - protein, 15 aa, Gallus gallus
AVGSSTSAAVGSILS

SEQ ID NO: 103 - protein, 15 aa, Gallus gallus
TAVGSSTSAAVGSIL

SEQ ID NO: 104 - protein, 14 aa, Gallus gallus
SGGFGISGLGSRFS

SEQ ID NO: 105 - protein, 13 aa, Gallus gallus
VVVTLPGPILSSF

SEQ ID NO: 106 - protein, 13 aa, Gallus gallus
PPPVVVTFPGPIL

SEQ ID NO: 107 - protein, 14 aa, Gallus gallus
GLGGFGWSGLGRGL

SEQ ID NO: 108 - protein, 13 aa, Gallus gallus
VTLPGPILSSFPQ

SEQ ID NO: 109 - protein, 14 aa, Gallus gallus
AVGSILSEEGVPIS

SEQ ID NO: 110 - protein, 14 aa, Gallus gallus
SLGLGGFGWSGLGR

SEQ ID NO: 111 - protein, 14 aa, Gallus gallus
PSPVVVTLPGPILS

SEQ ID NO: 112 - protein, 13 aa, Gallus gallus
SRVVIQPSPVVVT

SEQ ID NO: 113 - protein, 15 aa, Gallus gallus
SGGFGISGLGSRFSG

SEQ ID NO: 114 - protein, 14 aa, Gallus gallus
PPPVVVTLPGPILS

SEQ ID NO: 115 - protein, 14 aa, Gallus gallus
VAIQPPPVVVTLPG

SEQ ID NO: 116 - protein, 15 aa, Gallus gallus
PISSGGFGISGLGSR

SEQ ID NO: 117 - protein, 13 aa, Gallus gallus
PIVDVAEALLHVK

SEQ ID NO: 118 - protein, 14 aa, Gallus gallus
VVIQPSPVVVTLPG

SEQ ID NO: 119 - protein, 13 aa, Gallus gallus
RVVIQPSPVVVTL

SEQ ID NO: 120 - protein, 16 aa, Gallus gallus
TAVGSSTSAAVGSILS

SEQ ID NO: 121 - protein, 14 aa, Gallus gallus
PPPVVVTFPGPILS

SEQ ID NO: 122 - protein, 15 aa, Gallus gallus
SLGLGGFGWSGLGRG

SEQ ID NO: 123 - protein, 14 aa, Gallus gallus
VVVTLPGPILSSFP

SEQ ID NO: 124 - protein, 14 aa, Gallus gallus
PVVVTLPGPILSSF

SEQ ID NO: 125 - protein, 15 aa, Gallus gallus
AAVGSILSEEGVPIS

SEQ ID NO: 126 - protein, 15 aa, Gallus gallus
SAAVGSILSEEGVPI

SEQ ID NO: 127 - protein, 16 aa, Gallus gallus
EGVPISSGGFGISGLG

SEQ ID NO: 128 - protein, 14 aa, Gallus gallus
VVTLPGPILSSFPQ

SEQ ID NO: 129 - protein, 15 aa, Gallus gallus
PSPVVVTLPGPILSS

SEQ ID NO: 130 - protein, 16 aa, Gallus gallus
GKDGPKGVRGDAGPPG

SEQ ID NO: 131 - protein, 15 aa, Gallus gallus
SVAIQPPPVVVTLPG

SEQ ID NO: 132 - protein, 14 aa, Gallus gallus
SRVVIQPSPVVVTL

SEQ ID NO: 133 - protein, 14 aa, Gallus gallus
LHTEAAATVPDRSE

SEQ ID NO: 134 - protein, 15 aa, Gallus gallus
VVIQPSPVVVTLPGP

SEQ ID NO: 135 - protein, 14 aa, Gallus gallus
RVVIQPSPVVVTLP

SEQ ID NO: 136 - protein, 16 aa, Gallus gallus
SAAVGSILSEEGVPIS

SEQ ID NO: 137 - protein, 15 aa, Gallus gallus
PVVVTLPGPILSSFP

SEQ ID NO: 138 - protein, 15 aa, Gallus gallus
IQPSPVVVTLPGPIL

SEQ ID NO: 139 - protein, 17 aa, Gallus gallus
SVPIGAGGSLGLGGFGW

SEQ ID NO: 140 - protein, 16 aa, Gallus gallus
SLGLGGFGWSGLGRGL

SEQ ID NO: 141 - protein, 17 aa, Gallus gallus
FGGGFGGGDGILPAGEK

SEQ ID NO: 142 - protein, 17 aa, Gallus gallus
TAVGSSTSAAVGSILSE

SEQ ID NO: 143 - protein, 16 aa, Gallus gallus
PISSGGFGISGLGSRF

SEQ ID NO: 144 - protein, 19 aa, Gallus gallus
SAAVGSSLSAGSVPIGAGG

SEQ ID NO: 145 - protein, 17 aa, Gallus gallus
GVPISSGGFGISGLGSR

SEQ ID NO: 146 - protein, 15 aa, Gallus gallus
VVVTLPGPILSSFPQ

SEQ ID NO: 147 - protein, 15 aa, Gallus gallus
RVVIQPSPVVVTLPG

SEQ ID NO: 148 - protein, 15 aa, Gallus gallus
SRVVIQPSPVVVTLP

SEQ ID NO: 149 - protein, 16 aa, Gallus gallus
PSPVVVTLPGPILSSF

SEQ ID NO: 150 - protein, 16 aa, Gallus gallus
AIQPPPVVVTLPGPIL

SEQ ID NO: 151 - protein, 16 aa, Gallus gallus
IQPSPVVVTLPGPILS

SEQ ID NO: 152 - protein, 16 aa, Gallus gallus
VIQPSPVVVTLPGPIL

SEQ ID NO: 153 - protein, 17 aa, Gallus gallus
VPISSGGFGISGLGSRF

SEQ ID NO: 154 - protein, 16 aa, Gallus gallus
SRVVIQPSPVVVTLPG

SEQ ID NO: 155 - protein, 17 aa, Gallus gallus
SILSEEGVPISSGGFGI

SEQ ID NO: 156 - protein, 16 aa, Gallus gallus
PVVVTLPGPILSSFPQ

SEQ ID NO: 157 - protein, 16 aa, Gallus gallus
RVVIQPSPVVVTLPGP

SEQ ID NO: 158 - protein, 18 aa, Gallus gallus
SAAVGSILSEEGVPISSG

SEQ ID NO: 159 - protein, 16 aa, Gallus gallus
VVVTLPGPILSSFPQN

SEQ ID NO: 160 - protein, 18 aa, Gallus gallus
GVPISSGGFGISGLGSRF

SEQ ID NO: 161 - protein, 17 aa, Gallus gallus
PSPVVVTLPGPILSSFP

SEQ ID NO: 162 - protein, 17 aa, Gallus gallus
VAIQPPPVVVTLPGPIL

SEQ ID NO: 163 - protein, 17 aa, Gallus gallus
VIQPSPVVVTLPGPILS

SEQ ID NO: 164 - protein, 17 aa, Gallus gallus
VVIQPSPVVVTLPGPIL

SEQ ID NO: 165 - protein, 17 aa, Gallus gallus
SPVVVTLPGPILSSFPQ

SEQ ID NO: 166 - protein, 15 aa, Gallus gallus
VILSNTKTQYSIKIH

SEQ ID NO: 167 - protein, 17 aa, Gallus gallus
SRVVIQPSPVVVTLPGP

SEQ ID NO: 168 - protein, 17 aa, Gallus gallus
DSRVVIQPSPVVVTLPG

SEQ ID NO: 169 - protein, 17 aa, Gallus gallus
PVVVTLPGPILSSFPQN

SEQ ID NO: 170 - protein, 17 aa, Gallus gallus
RVVIQPSPVVVTLPGPI

SEQ ID NO: 171 - protein, 19 aa, Gallus gallus
GVPISSGGFGISGLGSRFS

SEQ ID NO: 172 - protein, 18 aa, Gallus gallus
SVAIQPPPVVVTLPGPIL

SEQ ID NO: 173 - protein, 18 aa, Gallus gallus
VAIQPPPVVVTLPGPILS

SEQ ID NO: 174 - protein, 18 aa, Gallus gallus
VVIQPSPVVVTLPGPILS

SEQ ID NO: 175 - protein, 18 aa, Gallus gallus
PSPVVVTLPGPILSSFPQ

SEQ ID NO: 176 - protein, 20 aa, Gallus gallus
GVPISSGGFGISGLGSRFSG

SEQ ID NO: 177 - protein, 18 aa, Gallus gallus
AVPLVRPVTMVPSIPGIP

SEQ ID NO: 178 - protein, 18 aa, Gallus gallus
PPPVVVTLPGPILSSFPQ

SEQ ID NO: 179 - protein, 18 aa, Gallus gallus
SPVVVTLPGPILSSFPQN

SEQ ID NO: 180 - protein, 18 aa, Gallus gallus
LPGPGLQLLHGTTTLAFK

SEQ ID NO: 181 - protein, 18 aa, Gallus gallus
PPPVVVTFPGPILSSFPQ

SEQ ID NO: 182 - protein, 19 aa, Gallus gallus
SVAIQPPPVVVTLPGPILS

SEQ ID NO: 183 - protein, 19 aa, Gallus gallus
SSVAIQPPPVVVTLPGPIL

SEQ ID NO: 184 - protein, 18 aa, Gallus gallus
RVVIQPSPVVVTLPGPIL

SEQ ID NO: 185 - protein, 19 aa, Gallus gallus
PSPVVVTLPGPILSSFPQN

SEQ ID NO: 186 - protein, 21 aa, Gallus gallus
SILSEEGVPISSGGFGISGLG

SEQ ID NO: 187 - protein, 19 aa, Gallus gallus
SRVVIQPSPVVVTLPGPIL

SEQ ID NO: 188 - protein, 19 aa, Gallus gallus
RVVIQPSPVVVTLPGPILS

SEQ ID NO: 189 - protein, 22 aa, Gallus gallus
SVPIGAGGSLGLGGFGWSGLGR

SEQ ID NO: 190 - protein, 22 aa, Gallus gallus
TAVGSSTSAAVGSILSEEGVPI

SEQ ID NO: 191 - protein, 22 aa, Gallus gallus
SAAVGSILSEEGVPISSGGFGI

SEQ ID NO: 192 - protein, 21 aa, Gallus gallus
SEEGVPISSGGFGISGLGSRF

SEQ ID NO: 193 - protein, 20 aa, Gallus gallus
SRVVIQPSPVVVTLPGPILS

SEQ ID NO: 194 - protein, 23 aa, Gallus gallus
SVPIGAGGSLGLGGFGWSGLGRG

SEQ ID NO: 195 - protein, 20 aa, Gallus gallus
DSRVVIQPSPVVVTLPGPIL

SEQ ID NO: 196 - protein, 23 aa, Gallus gallus
TAVGSSTSAAVGSILSEEGVPIS

SEQ ID NO: 197 - protein, 22 aa, Gallus gallus
LRGDVGPVGRTGEQGIAGPPGF

SEQ ID NO: 198 - protein, 21 aa, Gallus gallus
SRVVIQPSPVVVTLPGPILSS

SEQ ID NO: 199 - protein, 21 aa, Gallus gallus
VVIQPSPVVVTLPGPILSSFP

SEQ ID NO: 200 - protein, 22 aa, Gallus gallus
GVPISSGGFGISGLGSRFSGRR

SEQ ID NO: 201 - protein, 24 aa, Gallus gallus
SVPIGAGGSLGLGGFGWSGLGRGL

SEQ ID NO: 202 - protein, 21 aa, Gallus gallus
DSRVVIQPSPVVVTLPGPILS

SEQ ID NO: 203 - protein, 21 aa, Gallus gallus
VIQPSPVVVTLPGPILSSFPQ

SEQ ID NO: 204 - protein, 24 aa, Gallus gallus
AVGSILSEEGVPISSGGFGISGLG

SEQ ID NO: 205 - protein, 21 aa, Gallus gallus
RVVIQPSPVVVTLPGPILSSF

SEQ ID NO: 206 - protein, 23 aa, Gallus gallus
SILSEEGVPISSGGFGISGLGSR

SEQ ID NO: 207 - protein, 21 aa, Gallus gallus
IPSSVPESSFKIKGNSSSFHI

SEQ ID NO: 208 - protein, 22 aa, Gallus gallus
VAIQPPPVVVTLPGPILSSFPQ

SEQ ID NO: 209 - protein, 25 aa, Gallus gallus
TAVGSSTSAAVGSILSEEGVPISSG

SEQ ID NO: 210 - protein, 22 aa, Gallus gallus
VVIQPSPVVVTLPGPILSSFPQ

SEQ ID NO: 211 - protein, 23 aa, Gallus gallus
PSPVVVTLPGPILSSFPQNTAVG

SEQ ID NO: 212 - protein, 20 aa, Gallus gallus
KENFEVLCKDGTRKPVTDAE

SEQ ID NO: 213 - protein, 21 aa, Gallus gallus
SIQACKLAQSHGWGVMVSHRS

SEQ ID NO: 214 - protein, 22 aa, Gallus gallus
SRVVIQPSPVVVTLPGPILSSF

SEQ ID NO: 215 - protein, 22 aa, Gallus gallus
RVVIQPSPVVVTLPGPILSSFP

SEQ ID NO: 216 - protein, 23 aa, Gallus gallus
EQPPLCVASVSVKEPASETPAVP

SEQ ID NO: 217 - protein, 23 aa, Gallus gallus
SVAIQPPPVVVTLPGPILSSFPQ

SEQ ID NO: 218 - protein, 26 aa, Gallus gallus
SAAVGSILSEEGVPISSGGFGISGLG

SEQ ID NO: 219 - protein, 24 aa, Gallus gallus
SILSEEGVPISSGGFGISGLGSRF

SEQ ID NO: 220 - protein, 24 aa, Gallus gallus
PSPVVVTLPGPILSSFPQNTAVGS

SEQ ID NO: 221 - protein, 23 aa, Gallus gallus
VVIQPSPVVVTLPGPILSSFPQN

SEQ ID NO: 222 - protein, 23 aa, Gallus gallus
SRVVIQPSPVVVTLPGPILSSFP

SEQ ID NO: 223 - protein, 24 aa, Gallus gallus
SSVAIQPPPVVVTLPGPILSSFPQ

SEQ ID NO: 224 - protein, 23 aa, Gallus gallus
RVVIQPSPVVVTLPGPILSSFPQ

SEQ ID NO: 225 - protein, 25 aa, Gallus gallus
SILSEEGVPISSGGFGISGLGSRFS

SEQ ID NO: 226 - protein, 27 aa, Gallus gallus
TSAAVGSILSEEGVPISSGGFGISGLG

SEQ ID NO: 227 - protein, 26 aa, Gallus gallus
SILSEEGVPISSGGFGISGLGSRFSG

SEQ ID NO: 228 - protein, 24 aa, Gallus gallus
SRVVIQPSPVVVTLPGPILSSFPQ

SEQ ID NO: 229 - protein, 28 aa, Gallus gallus
TAVGSSTSAAVGSILSEEGVPISSGGFG

SEQ ID NO: 230 - protein, 28 aa, Gallus gallus
STSAAVGSILSEEGVPISSGGFGISGLG

SEQ ID NO: 231 - protein, 24 aa, Gallus gallus
RVVIQPSPVVVTLPGPILSSFPQN

SEQ ID NO: 232 - protein, 25 aa, Gallus gallus
SRVVIQPSPVVVTLPGPILSSFPQN

SEQ ID NO: 233 - protein, 25 aa, Gallus gallus
DSRVVIQPSPVVVTLPGPILSSFPQ

SEQ ID NO: 234 - protein, 29 aa, Gallus gallus
TAVGSSTSAAVGSILSEEGVPISSGGFGI

SEQ ID NO: 235 - protein, 29 aa, Gallus gallus
SAAVGSILSEEGVPISSGGFGISGLGSRF

SEQ ID NO: 236 - protein, 24 aa, Gallus gallus
VEQLVNLQHLDVAYNLLLEHAQLA

SEQ ID NO: 237 - protein, 28 aa, Gallus gallus
SVAIQPPPVVVTLPGPILSSFPQSTAVG

SEQ ID NO: 238 - protein, 28 aa, Gallus gallus
SILSEEGVPISSGGFGISGLGSRFSGRR

SEQ ID NO: 239 - protein, 30 aa, Gallus gallus
TSAAVGSILSEEGVPISSGGFGISGLGSRF

SEQ ID NO: 240 - protein, 29 aa, Gallus gallus
SSVAIQPPPVVVTLPGPILSSFPQSTAVG

SEQ ID NO: 241 - protein, 31 aa, Gallus gallus
STSAAVGSILSEEGVPISSGGFGISGLGSRF

SEQ ID NO: 242 - protein, 31 aa, Gallus gallus
PSPVVVTLPGPILSSFPQNTAVGSSTSAAVG

SEQ ID NO: 243 - protein, 33 aa, Gallus gallus
TAVGSSTSAAVGSILSEEGVPISSGGFGISGLG

SEQ ID NO: 244 - protein, 31 aa, Gallus gallus
AVGSILSEEGVPISSGGFGISGLGSRFSGRR

SEQ ID NO: 245 - protein, 27 aa, Gallus gallus
NKVLVHCAMGRSRSATLVLAYLMIYKN

SEQ ID NO: 246 - protein, 32 aa, Gallus gallus
SSVAIQPPPVVVTLPGPILSSFPQSTAVGSTA

SEQ ID NO: 247 - protein, 32 aa, Gallus gallus
AAVGSILSEEGVPISSGGFGISGLGSRFSGRR

SEQ ID NO: 248 - protein, 35 aa, Gallus gallus
TAVGSSTSAAVGSILSEEGVPISSGGFGISGLGSR

SEQ ID NO: 249 - protein, 33 aa, Gallus gallus
SAAVGSILSEEGVPISSGGFGISGLGSRFSGRR

SEQ ID NO: 250 - protein, 34 aa, Gallus gallus
PSPVVVTLPGPILSSFPQNTAVGSSTSAAVGSIL

SEQ ID NO: 251 - protein, 35 aa, Gallus gallus
PSPVVVTLPGPILSSFPQNTAVGSSTSAAVGSILS

SEQ ID NO: 252 - protein, 36 aa, Gallus gallus
TAVGSSTSAAVGSILSEEGVPISSGGFGISGLGSRF

SEQ ID NO: 253 - protein, 29 aa, Gallus gallus
RPRVYLHCTNPRHPKYREGDVTLFALNLS